(19) United States
(12) Patent Application Publication
(10) Pub. No.: US 2011/0263301 A1
(43) Pub. Date: Oct. 27, 2011

(54) Bluetooth Control System for Mobile Devices Used In A Car

(76) Inventor: Chen-Lin Chang, Shindian City (TW)

(21) Appl. No.: 12/831,293

(22) Filed: Jul. 7, 2010

(30) Foreign Application Priority Data
Apr. 27, 2010 (TW) 099113325

(51) Int. Cl. H04M 1/00; H04B 1/00

(52) U.S. Cl. 455/569.2; 381/86

(57) ABSTRACT

A Bluetooth control system for mobile devices used in a car is disclosed for controlling Bluetooth communication. The Bluetooth control system comprises a separated controller and a main controlling box. The separated controller comprises a control panel and a controller board. When a user presses the control panel, the controller board issues a control signal correspondingly. The main controlling box comprises a Bluetooth module for communication with the mobile device, a digital signal processing module electrically connected to the Bluetooth module, and a control module electrically connected to the Bluetooth module and the digital signal processing module, respectively. The control module comprises a microprocessor for controlling the Bluetooth communication between the mobile device and the Bluetooth module, transforming a digital signal from the mobile device into an analog signal, and transmitting the analog signal to a speaker, according to the control signal from the separated controller.

### BACKGROUND OF THE INVENTION

1. Field of the Invention

The present invention relates to a Bluetooth control system; more particularly, the present invention relates to a Bluetooth control system having a separated controller for mobile devices used in a car so as to respond to or terminate communications of a wireless mobile device.

2. Description of the Related Art

For the driving safety, a variety of Bluetooth control devices have been developed in the market today, so a user can talk on a cell phone while driving without safety concerns. However, conventional wired or wireless Bluetooth headsets or earphones may always cause ear discomfort after prolonged use.

Currently, Bluetooth control devices are all designed in one piece. For example, Sony® DRC-BT15P (model name) Bluetooth audio receiver is a kind of Bluetooth wireless audio controller, which allows a user to carry the Bluetooth wireless audio controller either by clamping it on a pocket or by hanging it on neck. However, mostly, the user would use the Bluetooth control device in a car, such as talking on a cell phone in a hands-free mode while driving. Therefore, the Bluetooth wireless audio controller might easily get lost if the user always carries it about.

Further, in order to achieve the carry-on convenience, a conventional Bluetooth wireless audio controller is driven by a battery. Therefore, there's always a possibility of running out of power, which may instead lose the desired functionality of the Bluetooth control device.

Therefore, there is a need to provide a Bluetooth control system for mobile devices used in a car to mitigate and/or obviate the aforementioned problems.

### SUMMARY OF THE INVENTION

It is an objective of the present invention to provide a Bluetooth control system having a separated controller for mobile devices used in a car. It is another object of the present invention to provide a Bluetooth control system for mobile devices used in a car, wherein a separated controller can be either inserted into an automobile cigarette lighter receptacle or fastened to a panel body of the car. It is yet another object of the present invention to provide a Bluetooth control system for mobile devices used in a car, wherein a separated controller is a wireless remote controller.

To achieve the abovementioned objectives, the present invention provides a Bluetooth control system for mobile devices used in a car, used for controlling Bluetooth communications of a mobile device. The mobile device can be a cell phone, a personal digital assistant or any equivalent device.

In one preferred embodiment, a main controlling box comprises a RF transceiver module electrically connected to a control module, wherein a RF control module and the RF transceiver module correspond to each other. When the user presses a control panel to make a controller board issue a control signal, the control signal is substantially a RF signal; which means, when the user presses the control panel, the RF control module issues the RF signal.

In this embodiment, the separated controller comprises a casing, which fits an automobile cigarette lighter receptacle. The separated controller comprises a plurality of electrical contact parts sticking out through the casing, and the controller board comprises a plurality of corresponding electrical connection parts. When the separated controller is inserted into the automobile cigarette lighter receptacle, power can be supplied to the controller board through the contact between the plurality of electrical contact parts and the automobile cigarette lighter receptacle.

In this embodiment, the casing further comprises an upper lid and a lower lid. The upper lid and the lower lid correspond to each other. The upper lid and the lower lid can be assembled to fit the automobile cigarette lighter receptacle. Preferably, the upper lid and the lower lid further comprise a spring, respectively. The springs can provide elasticity to fasten the separated controller to the automobile cigarette lighter receptacle.

The Bluetooth control system for mobile devices used in a car can further comprise a microphone. The microphone is electrically connected to the digital signal processing module of the main controlling box. When the user talks to the microphone, an analog speech signal is generated, and the microprocessor utilizes the digital signal processing module to convert the analog speech signal from the microphone into a digital speech signal, and then transmits the digital speech signal to the mobile device via the Bluetooth module.

In this embodiment, the main controlling box further comprises an amplifier module. The amplifier module is electrically connected to the digital signal processing module, the control module and the speaker, respectively. Before the analog signal is transmitted to the speaker, the amplifier module amplifies the analog signal and drives the speaker.

Preferably, if the analog signal is transmitted to the speaker of the car, the main controlling box can further comprise an audio control circuit. The audio control circuit is electrically connected to the speaker, the control module and the amplifier module, respectively. According to the control signal, the microprocessor can stop an audio playback (such as stop the radio broadcast) via the audio control circuit. Then, according to the control signal, the microprocessor can transmit the analog signal to the speaker via the audio control circuit.

In another preferred embodiment, when the user presses the control panel, another control button controls the controller board to further issue a noise control signal. The microprocessor further controls the digital signal processing module to perform an anti-noise process to the analog signal according to the noise control signal.

Further, in another embodiment, the separated controller of the present invention controls the main controlling box in a wired mode, so as to perform Bluetooth communications with the mobile device. In this embodiment, the separated controller and the main controlling box are electrically connected to each other via a cable. The separated controller comprises a casing for covering the controller board. The casing is in the shape of a cylinder. The cylinder can be located on a panel body of a car, and the panel body is fastened to the cylinder via a fastening part, such that the separated controller can be fastened to the panel body. Preferably, the cylinder has a thread, and the fastening part is a screw nut. By means of screwing the screw nut onto the cylinder with the thread, the separated controller can be fastened to the panel body accordingly.

Therefore, the present invention further provides a separated controller used for controlling a Bluetooth control system for mobile devices used in a car. The separated controller can control the Bluetooth control system for mobile devices used in a car in either a wireless or a wired mode.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a system architecture diagram of a Bluetooth control system for mobile devices used in a car according to the present invention.

FIG. 2 illustrates a functional block diagram of the Bluetooth control system for mobile devices used in a car according to one embodiment of the present invention.

FIG. 3 illustrates a schematic perspective exploded view of a separated controller according to one embodiment of the present invention.

FIG. 4 illustrates a use case scenario according to the separated controller shown in FIG. 3.

FIG. 5 illustrates a perspective cross-sectional view of a use case scenario of the separated controller according to another embodiment of the present invention.

FIG. 6 illustrates a functional block diagram of the Bluetooth control system for mobile devices used in a car according to another embodiment of the present invention.

### DETAILED DESCRIPTION OF THE PREFERRED EMBODIMENT

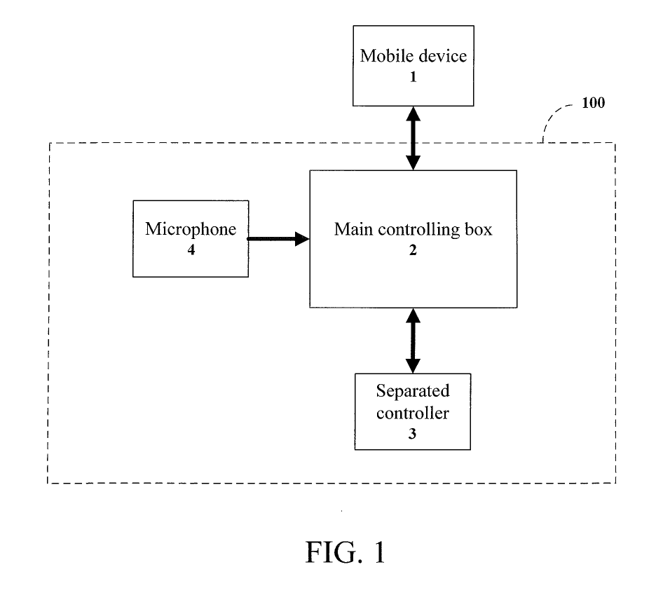

Please refer to FIG. 1, which illustrates a system architecture diagram of a Bluetooth control system for mobile devices used in a car according to the present invention. The present invention provides a Bluetooth control system 100 for mobile devices used in a car, and used for controlling Bluetooth communications of a mobile device 1. The present invention utilizes a separated controller 3 to control a main controlling box 2, so as to perform Bluetooth communications with the mobile device 1. The mobile device 1 can be a cell phone, a personal digital assistant or any equivalent device.

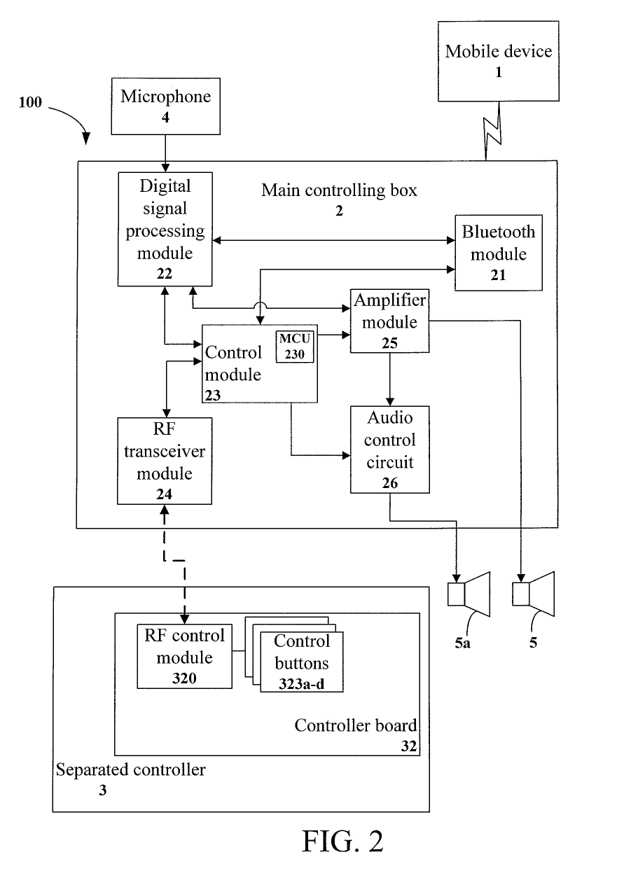

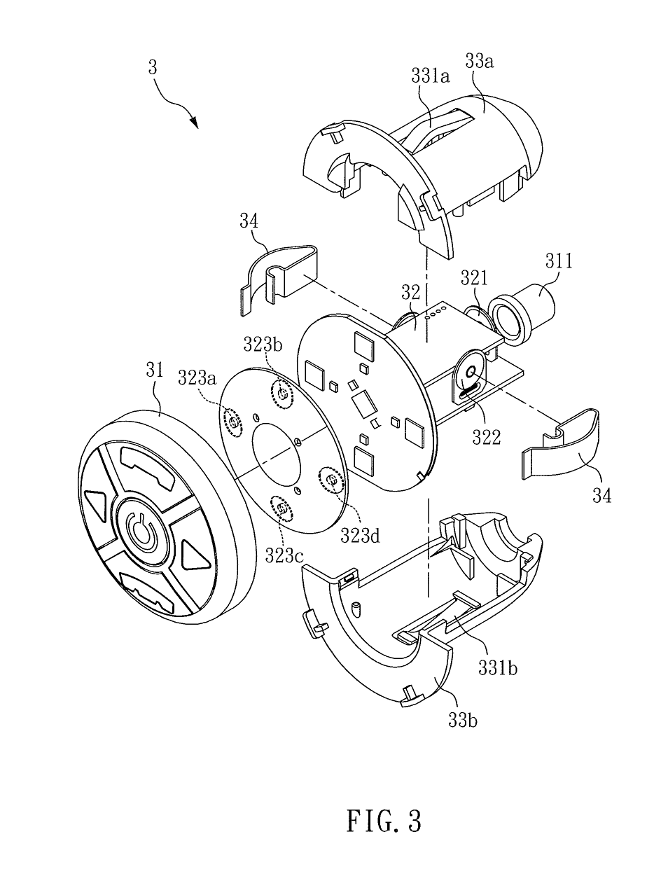

Please refer to FIG. 2 and FIG. 3. The Bluetooth control system 100 comprises a separated controller 3 and a main controlling box 2. As shown in FIG. 3, the separated controller 3 comprises a control panel 31 and a controller board 32. The controller board 32 comprises at least one control button 323a. In this embodiment, the controller board 32 comprises control buttons 323a-d, wherein the control panel 31 and each of the control buttons 323a-d contact with each other. When a user presses the control panel 31, one of the control buttons 323a-d can control the controller board 32 to issue a control signal correspondingly. For example, the control panel 31 may comprise multiple types of symbols, and each of them represents a different function. When the user presses an answering symbol located in the upper edge of the control panel 31, the control button 323b is then activated, so as to drive the controller board 32 to issue a control signal for answering a phone call. A more detailed explanation will be described hereinafter.

Please return to FIG. 2. The main controlling box 2 comprises a Bluetooth module 21, a digital signal processing module 22 and a control module 23. The Bluetooth module 21 is used for performing Bluetooth communications with the mobile device 1. The digital signal processing module 22 is electrically connected to the Bluetooth module 21. The control module 23 comprises a microprocessor 230. The control module 23 is electrically connected to the Bluetooth module 21 and the digital signal processing module 22, respectively. According to the control signal from the separated controller 3, the microprocessor 230 activates Bluetooth communications between the mobile device 1 and the Bluetooth module 21, utilizes the digital signal processing module 22 to convert a digital signal from the mobile device 1 into an analog signal, and transmits the analog signal to a speaker 5 or 5a. For example, when the user presses the answering symbol located in the upper edge of the control panel 31, the control button 323b is then activated, so as to drive the controller board 32 to issue the control signal for answering the phone call. At this time, according to the control signal from the separated controller 3, the microprocessor 230 activates Bluetooth communications between the mobile device 1 and the Bluetooth module 21, utilizes the digital signal processing module 22 to convert the digital signal from the mobile device 1 into the analog signal, and transmits the analog signal to the speaker 5 or 5a. Preferably, the analog signal is amplified via an amplifier module 25 before being outputted to the speaker 5 or 5a.

Moreover, the Bluetooth control system 100 can further comprise a microphone 4. The microphone 4 is electrically connected to the digital signal processing module 22 of the main controlling box 2. When the user talks to the microphone 4, an analog speech signal is generated, and the microprocessor 230 utilizes the digital signal processing module 22 to convert the analog speech signal from the microphone 4 into a digital speech signal, and transmits the digital speech signal to the mobile device 1 via the Bluetooth module 21.

In this embodiment, the main controlling box 2 further comprises an amplifier module 25. The amplifier module 25 is electrically connected to the digital signal processing module 22, the control module 23 and the speaker 5 or 5a, respectively. Before the analog signal is transmitted to the speaker 5 or 5a, the amplifier module 25 is used to amplify the analog signal and to drive the speaker 5 or 5a. Therefore, the user can choose to install an additional set of speaker 5, which is electrically connected to the amplifier module 25 directly, rather than using the built-in speaker 5a of the car to output the analog signal. Further, by means of pressing the control panel 31, the user can activate other control buttons 323a or 323d to control the controller board 32, so as to drive the controller board 32 to further issue other control signals, such as a control signal for adjusting the volume of the speaker 5 or 5a. However, the above description is only one of the possible embodiments of the present invention. The control signals can be designed with other functions, which can be accomplished by means of pressing the control panel 31, such as power activation or communication termination without being limited to the above description.

Preferably, if the analog signal is transmitted to the speaker 5a of the car, the main controlling box 2 can further comprise an audio control circuit 26. The audio control circuit 26 is electrically connected to the speaker 5a, the control module 23 and the amplifier module 25, respectively. According to the control signal (such as the control signal for answering a phone call), the microprocessor 230 can stop an audio playback (such as stop the radio broadcast) via the audio control circuit 26. Then, according to the control signal, the microprocessor 230 can transmit the analog signal to the speaker 5a of the car via the audio control circuit 26. As a result, when the user is driving, even when the user is listening to the radio, he/she can directly answer the mobile device 1 via the Bluetooth control system for mobile devices used in a car 100 of the present invention without switching the audio sources.

Furthermore, the user can further press the control panel 31 to activate other control buttons 323a or 323d to control the controller board 32, so as to drive the controller board 32 to further issue a noise control signal, and the microprocessor 230 further controls the digital signal processing module 22 to perform an anti-noise process to the analog signal according to the noise control signal. Therefore, the user can adjust the anti-noise process according to an actual situation, so as to obtain better playback sound (outputted from the mobile device 1) via the speaker 5 or 5a.

In one embodiment of the present invention, as shown in FIG. 2, the separated controller 3 of the present invention controls the main controlling box 2 in a wireless mode, so as to perform Bluetooth communications with the mobile device 1. In this embodiment, the controller board 32 of the separated controller 3 further comprises a radio frequency (RF) control module 320 electrically connected to the control buttons 323a-d, and the main controlling box 2 further comprises a RF transceiver module 24 electrically connected to the control module 23, wherein the RF control module 320 and the RF transceiver module 24 correspond to each other. When the user presses the control panel 31 to make the controller board 32 issue the control signal, the control signal is substantially a RF signal; which means, when the user presses the control panel 31, it is the RF control module 320 which issues the RF signal.

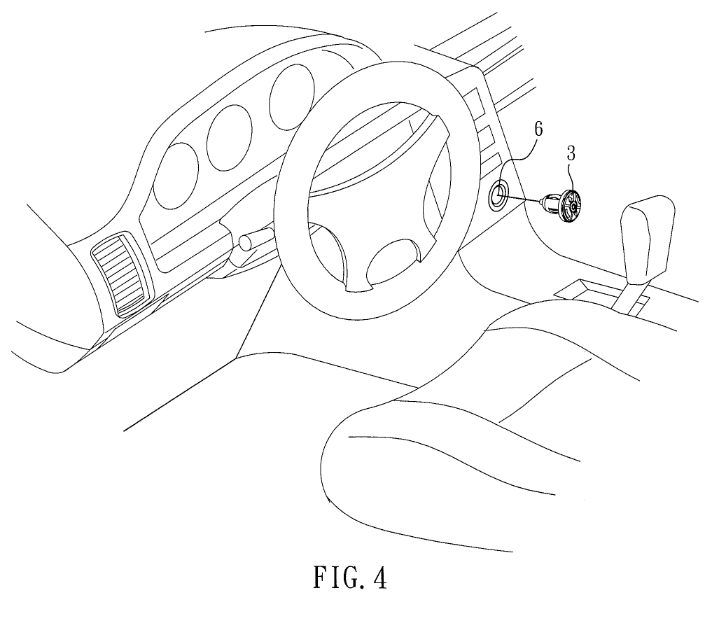

In this embodiment, please refer to both FIG. 3 and FIG. 4. The separated controller 3 comprises a casing substantially composed of an upper lid 33a and a lower lid 33b. The upper lid 33a and the lower lid 33b correspond to each other. The upper lid 33a and the lower lid 33b can be assembled to fit an automobile cigarette lighter receptacle 6 (as shown in FIG. 4). In other words, the casing fits the automobile cigarette lighter receptacle 6. The separated controller 3 comprises a plurality of electrical contact parts 34 and 311 sticking out through the casing, and the controller board 32 comprises a plurality of corresponding electrical connection parts 322 and 321. As shown in FIG. 4, when the separated controller 3 is inserted into the automobile cigarette lighter receptacle 6, power can be supplied to the controller board 32 through the contact between the plurality of electrical contact parts 34 and 311 (as shown in FIG. 3) and the automobile cigarette lighter receptacle 6.

In this embodiment, preferably, the upper lid 33a and the lower lid 33b further comprise a spring 331a and 331b, respectively. The springs 331a and 331b can provide elasticity to fasten the separated controller 3 to the automobile cigarette lighter receptacle 6.

As shown in FIG. 4, the user only needs to insert the separated controller 3 into the automobile cigarette lighter receptacle 6, such that the separated controller 3 can control the main controlling box 2 through the power supplied by the automobile cigarette lighter receptacle 6. The main controlling box 2 of the present invention can be stowed and locked in the glove compartment or other hidden area according to the design of the car. It is okay even if the user cannot touch the main controlling box 2 because the user can still control it only through the separated controller 3.

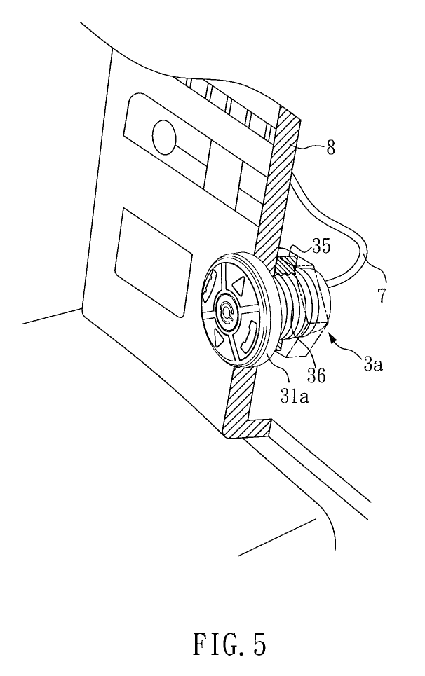

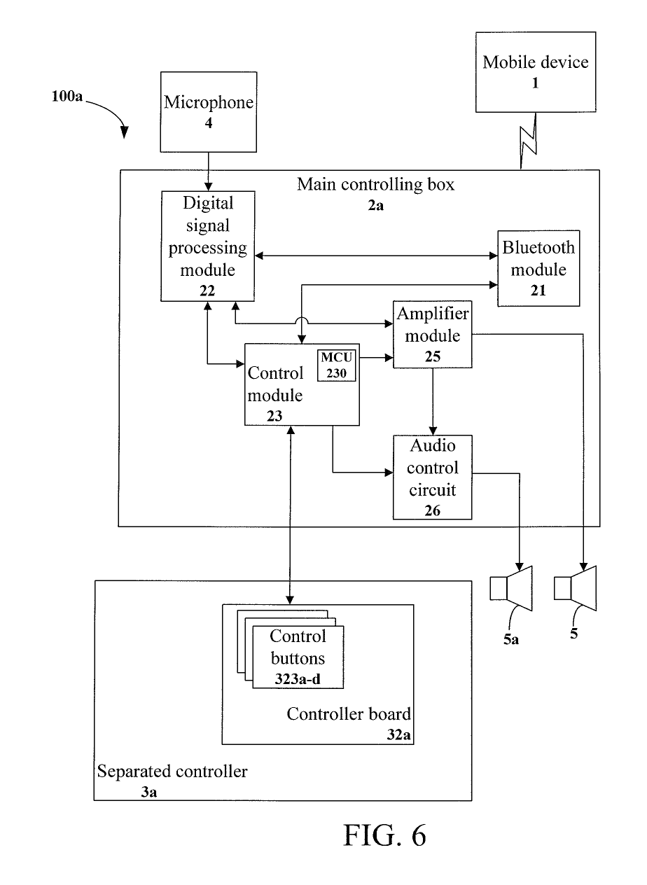

In the abovementioned embodiment, the separated controller 3 controls the main controlling box 2 in a wireless mode. However, in another embodiment of the present invention, the separated controller of the present invention can also control the main controlling box in a wired mode to perform Bluetooth communications with the mobile device. In this embodiment, please refer to both FIG. 5 and FIG. 6, the separated controller 3a and the main controlling box 2a are electrically connected to each other via a cable 7. Therefore, in this embodiment, the separated controller 3a can obtain power from the main controlling box 2a. The power of the main controlling box 2 or 2a may come from a car battery or an additional battery. Therefore is no need for further description of the power source for it is a known prior art.

As shown in FIG. 5, the separated controller 3a comprises a casing 36 for covering the controller board 32a (as shown in FIG. 6). The casing 36 is in the shape of a cylinder. The cylinder can be located on a panel body 8 (such as a panel body next to the dash board or the glove compartment without interfering the vehicle functionality) of the car, and the panel body is fastened to the cylinder via a fastening part 35, such that the separated controller 3a can be fastened to the panel body 8. Preferably, the casing 36 has a thread, and the fastening part 35 is a screw nut. By means of screwing the screw nut onto the cylinder with the thread, the separated controller 3a can be fastened to the panel body 8 accordingly.

Therefore, according to the above description, the present invention provides a separated controller 3 or 3a used for controlling a Bluetooth control system 100 or 100a for mobile devices used in a car. The separated controller 3 or 3a can control the Bluetooth control system 100 or 100a for mobile devices used in a car in either a wireless (such as the separated controller 3) or a wired (such as the separated controller 3a) mode. The separated controller 3 or 3a of the present invention can be either inserted into the automobile cigarette lighter receptacle 6 or fastened to the panel body 8 of the car. The characteristics of the present invention are that the user can control the Bluetooth control system 100 or 100a for mobile devices used in a car in a convenient way, and the separated controller 3 or 3a can utilize the power from the car without concerning about a low battery situation. Further, the separated controller 3 or 3a can be stowed in a fixed position without getting lost.

Although the present invention has been explained in relation to its preferred embodiments, it is to be understood that many other possible modifications and variations can be made without departing from the spirit and scope of the invention as hereinafter claimed.

What is claimed is:

1. A Bluetooth control system for mobile devices used in a car, used for controlling Bluetooth communications of a mobile device, the Bluetooth control system comprising:
a separated controller, comprising:
a control panel; and
a controller board, comprising at least one control button, wherein the control panel and each of the control button contact with each other, when a user presses the control panel, one of the control button controls the controller board to issue a control signal correspondingly;
and
a main controlling box, comprising:
a Bluetooth module, used for performing Bluetooth communications with the mobile device;
a digital signal processing module, electrically connected to the Bluetooth module; and
a control module, comprising a microprocessor, wherein the control module is electrically connected to the Bluetooth module and the digital signal processing module, respectively, and according to the control signal from the separated controller, the microprocessor activates Bluetooth communications between the mobile device and the Bluetooth module, utilizes the digital signal processing module to convert a digital signal from the mobile device into an analog signal, and transmits the analog signal to a speaker.

2. The Bluetooth control system for mobile devices used in a car as claimed in claim 1, wherein the controller board further comprises a radio frequency (RF) control module electrically connected to each of the control button, and the main controlling box further comprises a RF transceiver module, wherein the RF control module and the RF transceiver module correspond to each other, the RF transceiver module is electrically connected to the control module, and the control signal is substantially a RF signal issued by the RF control module.

3. The Bluetooth control system for mobile devices used in a car as claimed in claim 2, wherein the separated controller comprises a casing which fits an automobile cigarette lighter receptacle, the separated controller comprises a plurality of electrical contact parts sticking out through the casing, and the controller board comprises a plurality of corresponding electrical connection parts, such that when the separated controller is inserted into the automobile cigarette lighter receptacle, power can be supplied to the controller board through the contact between the plurality of electrical contact parts and the automobile cigarette lighter receptacle.

4. The Bluetooth control system for mobile devices used in a car as claimed in claim 3, wherein the casing further comprises an upper lid and a lower lid corresponding to each other, the upper lid and the lower lid can be assembled to fit the automobile cigarette lighter receptacle, and the upper lid and the lower lid further comprise a spring, respectively, wherein each spring helps fasten the separated controller to the automobile cigarette lighter receptacle.

5. The Bluetooth control system for mobile devices used in a car as claimed in claim 1 further comprising a microphone, wherein the microphone is electrically connected to the digital signal processing module of the main controlling box, such that when a user talks to the microphone, an analog speech signal is generated, and the microprocessor utilizes the digital signal processing module to convert the analog speech signal from the microphone into a digital speech signal, and transmits the digital speech signal to the mobile device via the Bluetooth module.

6. The Bluetooth control system for mobile devices used in a car as claimed in claim 5, wherein the main controlling box further comprises an amplifier module, the amplifier module is electrically connected to the digital signal processing module, the control module and the speaker, respectively, and before the analog signal is transmitted to the speaker, the amplifier module is used to amplifying the analog signal and to drive the speaker.

7. The Bluetooth control system for mobile devices used in a car as claimed in claim 6, wherein the main controlling box further comprises an audio control circuit, the audio control circuit is electrically connected to the speaker, the control module, and the amplifier module, respectively, and according to the control signal, the microprocessor stops an audio playback via the audio control circuit as well as transmits the analog signal to the speaker via the audio control circuit.

8. The Bluetooth control system for mobile devices used in a car as claimed in claim 7, wherein when the user presses the control panel, another control button controls the controller board to further issue a noise control signal, and the microprocessor further controls the digital signal processing module to perform an anti-noise process to the analog signal according to the noise control signal.

9. The Bluetooth control system for mobile devices used in a car as claimed in claim 1, wherein the separated controller and the main controlling box are electrically connected to each other via a cable, and the separated controller further comprises a casing for covering the controller board, wherein the casing is in the shape of a cylinder, the cylinder is located on a panel body of a car, and the panel body is fastened to the cylinder via a fastening part, such that the separated controller is fastened to the panel body.

10. The Bluetooth control system for mobile devices used in a car as claimed in claim 9, wherein the cylinder has a thread, and the fastening part is a screw nut.

11. The Bluetooth control system for mobile devices used in a car as claimed in claim 1, wherein the mobile device is a cell phone or a personal digital assistant.

12. A separated controller, used for controlling a Bluetooth control system for mobile devices used in a car, the separated controller comprising:
a control panel;
a controller board, comprising at least one control button and a RF control module, wherein the RF control module is electrically connected to each of the control button, the control panel and each of the control button contact with each other, when a user presses the control panel, one of the control button controls the RF control module to issue a RF signal for controlling the Bluetooth control system; and
a casing, fitting an automobile cigarette lighter receptacle, wherein when the separated controller is inserted into the automobile cigarette lighter receptacle, power can be supplied to the controller board through the contact between a plurality of electrical contact parts and the automobile cigarette lighter receptacle.

13. The separated controller as claimed in claim 12, wherein the casing further comprises an upper lid and a lower lid corresponding to each other, the upper lid and the lower lid can be assembled to fit the automobile cigarette lighter receptacle, and the upper and the lower lid further comprise a spring, respectively, wherein each spring helps fasten the separated controller to the automobile cigarette lighter receptacle.

14. A separated controller, used for controlling a Bluetooth control system for mobile devices used in a car, the separated controller comprising:
a control panel;
a controller board, comprising at least one control button, wherein the control panel and each of the control button contact with each other, when a user presses the control panel, one of the control button controls the controller board to issue a control signal for controlling the Bluetooth control system; and
a casing, covering the controller board, wherein the casing is in the shape of a cylinder, the cylinder is located on a panel body of a car, and the panel body is fastened to the cylinder via a fastening part, such that the separated controller is fastened to the panel body.

15. The separated controller as claimed in claim 14, wherein the cylinder has a thread, and the fastening part is a screw nut.
